(19) United States
(12) Patent Application Publication
(10) Pub. No.: US 2008/0144838 A1
(43) Pub. Date: Jun. 19, 2008

(54) Tamper resistant audio sound level detector and informative device

(76) Inventors: Janet S. Raines, Suwanee, GA (US); Jack Neil Bartholmae, Duluth, GA (US); James William O'Brien, Alpharetta, GA (US)

Correspondence Address: JANET RAINES, 9205 SPICEBRUSH DRIVE, AUSTIN, TX, 78759, US

(21) Appl. No.: 11/500,566

(22) Filed: Aug. 8, 2006

Related U.S. Application Data
(60) Provisional application No. 60/596,044, filed on Aug. 25, 2005.

(51) Int. Cl. H04R 29/00

(52) U.S. Cl. 381/56

(57) ABSTRACT

A Device is described that has been designed to detect the presence of audible sound levels and provide indication of the acceptability of those levels as relates to their transmission efficiency through walls, floors and ceilings to neighbors. The Device makes use of typical electronic circuitry to detect sound levels that are propagated through the air as well as sounds coupled physically through the Device's enclosure from the same surface to which the Device is mounted and to the same microphone or a multiplicity of microphones. Based on this information the Device shall provide visual and or audible indications that encourage the person or persons responsible to reduce the level of sound being emitted.

### CROSS REFERENCE TO RELATED APPLICATIONS

This patent application claims the benefit of provisional patent application Ser. No. 60/596,044 filed Aug. 25, 2005.

Several devices have been disclosed that monitor ambient sound level levels in a somewhat similar fashion and provide feedback to persons in proximity. These devices arose from needs to monitor sound levels in schools, nightclubs, auditoriums, work environments and other similar situations where sound levels could either be troublesome, annoying or dangerous.

U.S. Pat. No. 3,480,912 A sound level indicator for use in a classroom to indicate to a pupil when he is not speaking loud enough.

U.S. Pat. No. 3,440,349 An animated face structure which changes facial expressions in response to noise levels in a surrounding environment and includes adjacent light illuminating layers having different light reflecting mood expression grooves that are selectively illuminated by light sources which are selectively actuated by a sound pickup responsive means.

U.S. Pat. No. 3,304,368 The present invention relates to noise control for a school bus.

U.S. Pat. No. 4,424,511 A noise level monitoring and indicating system includes plural microphones distributed about a classroom, bus, etc. and adapted to drive individual counters to indicate the number of times a minimum sound level has been exceeded by the signal from the associated microphone.

### OTHER PUBLICATIONS

¹Accuracy of Prediction of Methods for Sound Transmission Loss—K. B. Ballagh

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The background of the invention is the arena of intrusive sound levels and the desire to limit those sound levels, often in the form of music, to levels that are not obtrusively offensive to inhabitants of adjacent rooms or areas, neighboring residences or adjacent locations.

Almost everyone has had the experience of occupying a room or residence next to an unknowing or uncaring neighbor who had adjusted their audio equipment or television to produce high levels of sound. A typical response would have been to call the apartment management, the dorm monitor, the hotel front desk, or in the case of a private residence, the police. Accordingly, for apartments, dorms or hotels there is strong motivation on the part of the management to find a preventative solution to the problem and reduce the need for the direct physical presence of management personnel for its resolution. What is clearly needed is a method of informing the offending party that the level of noise has a high probability of offending others and provide motivation to discontinue the offending level. In addition, a passive, non-confrontational device makes the process more autonomous and can lend itself to better noise conformance.

### BRIEF SUMMARY OF THE INVENTION

When an individual or individuals create a level of noise that is offensive to others some feedback is necessary to encourage improved behavior. This feedback may be provided in two tiers. The first tier may be an indication of the sound level in the area that is easily discernable but of a non-irritating form and may provide a clear indication of acceptability of the sound level or that the sound level is trending in the direction of unacceptability. The second tier may be of a nature that strongly encourages the offending inhabitant to correct the level of sound in his or her area because it has reached an unacceptable level.

The first tier requirements can be met with an audio level indicator that is surface mounted and easily visible to the inhabitant of the same room. The indicator will be capable of detecting and responding to only those frequencies of sound that are commonly transmitted through walls and floors and may have enough dynamic levels of indication so as to make it easy for an inhabitant to discern the level of sound in the room. The indicator may also provide an easily discernable indication of increasing or decreasing sound level and indication that the sound is at an acceptable level, nearing an unacceptable level or exceeding an unacceptable level and do so through the use of illuminated, commonly recognized and easily distinguished colors such as green, yellow and red, respectively.

The second tier requirements can be met by enabling an easily distinguishable, sonic alarm, possibly with irritating characteristics, when unacceptable sound levels are detected. The sonic alarm may be low enough in frequency to be audible to a majority of people, high enough in frequency so as to not be transmitted efficiently through walls and yet be very irritatingly obvious to the inhabitant from which the sounds are emanating that the present sound level conditions are unacceptable.

The overall goal of the above described functionality is to allow an inhabitant of a sound producing environment to have creditable indication as to the likelihood of the sound being at an offensive level and thus provide opportunity to the offending resident to take corrective action when necessary.

A device that incorporates the above functionality may include the following characteristics:
Inexpensive—Unlike environmental audio monitoring equipment, the device is designed to be relatively inexpensive and easily deployable. Prior disclosures were not directed at mass installations where cost per unit was a major consideration.
Frequency Selectivity—The device is particularly sensitive to frequencies that tend to pass through barriers readily. Prior disclosures described devices that responded to the entire audible frequency band without any emphasis on the lower frequencies that tend to be most offending.
Repetition Selectivity—The device may incorporate the ability discern pulsed sound emissions with a repetition common to music, as opposed to other common sounds such as door closings or thunder claps that might otherwise trigger the device. Prior disclosures often detected aggregate sound levels allowing for frequent alarm events caused by normal activities.
Mounting surface coupling—One common method of attempting to defeat a device of this type would be to cover the device with an acoustic barrier, such as adhesive backed tape. The device may use sound energy collected by the mounting surface to render such efforts to defeat method much less effective. Prior disclosures made no mention of using the mounting surface as a sound-receiving element for sound level detection.
Restricted Adjustment Access—Every structure transmits room-to-room sound with varying efficiency and thus some method must be provided to allow the installer to adjust the device for suitable noise level acceptance for a given room-to-room transmission efficiency. The device may be designed to restrict access to only the installer, maintenance personnel or management personnel.
Tamper Resistance—The device may be easily mountable to any standard 110 V standard duplex outlet that might be located on a typical wall, ceiling or similar surface using a security screw or locking mechanism and provide a means for indicating that tampering or tampering attempt has occurred. Prior disclosures made no mention of tamper resistance or prevention.
Unobtrusive Appearance—The device may be no more visually obtrusive than a common smoke detector and thus be a background element only seen or heard when necessary. Prior disclosures often were planned to entertain or be in significant evidence in their environment.

### BRIEF DESCRIPTION OF THE SEVERAL VIEWS OF THE DRAWING

FIG. 1 shows a block diagram of an example embodiment.

FIG. 2 shows an example embodiment of a circuit to adjust sensitivity.

FIG. 3 shows an example embodiment of a circuit to detect processed levels and present visual feedback.

FIG. 4 shows a side view of an example embodiment of the surface coupling to allow detection of sound energy.

### DETAILED DESCRIPTION OF THE INVENTION

The Device is secured to the mounting surface in a tamper resistant housing with access for installer, maintenance or management personnel adjustment of the audio level meter response sensitivity and alarm threshold.

The electronic function of this Device has two distinct phases of operation, Detection and Alarm.

### Detection Phase

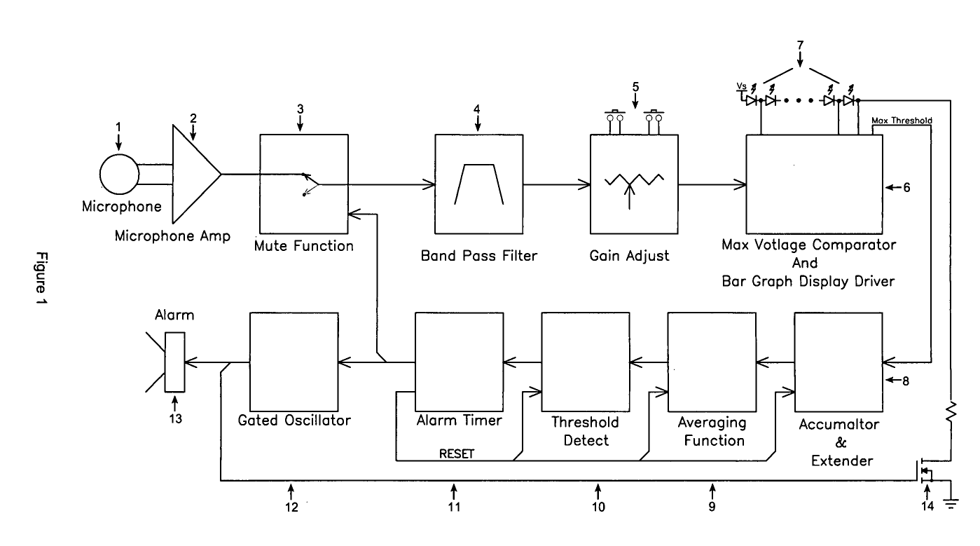

A block diagram of the disclosed Device is shown in FIG. 1. Microphone 1 is an Electret Condenser Microphone that converts variations in audible sound pressure to an electrical signal. This electrical signal is amplified by amplifier 2 to allow for more accurate downstream processing.

During the detection phase of operation of this device, the Mute Function 3 is in the position that connects microphone amplifier 2 to band pass filter 4. Band pass filter 4 selects the lower frequency components of the amplified electrical signal in the range of 10 to 1000 Hertz for further processing and greatly attenuates those outside of that band, as those of higher frequencies do not typically transmit efficiently through walls (see reference 1) or, in the case of the frequencies below 10 Hz, those are not typically produced by conventional audio equipment.

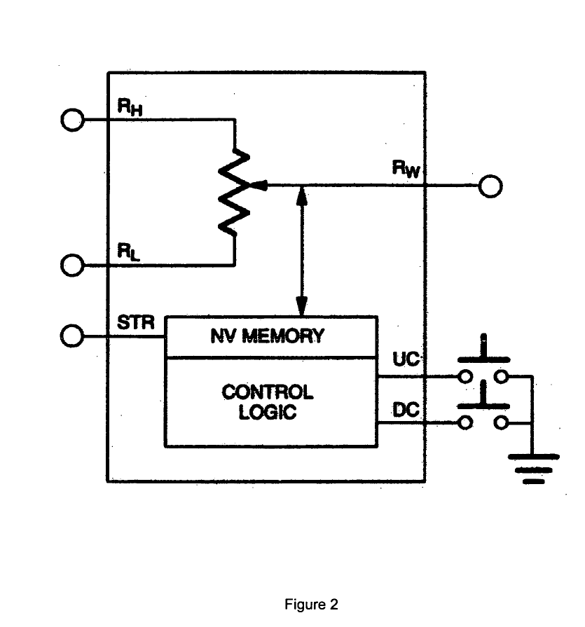

Because of varying room size and wall construction techniques and associated variance in transmission efficiencies of same, gain adjustment 5 is included in the signal path to allow for compensating adjustment of gain. In this disclosure, this function is implemented using a digitally controlled potentiometer, as shown in FIG. 2, simplifying the adjustment procedure by substituting push button switches that can be actuated without the use of any special tools.

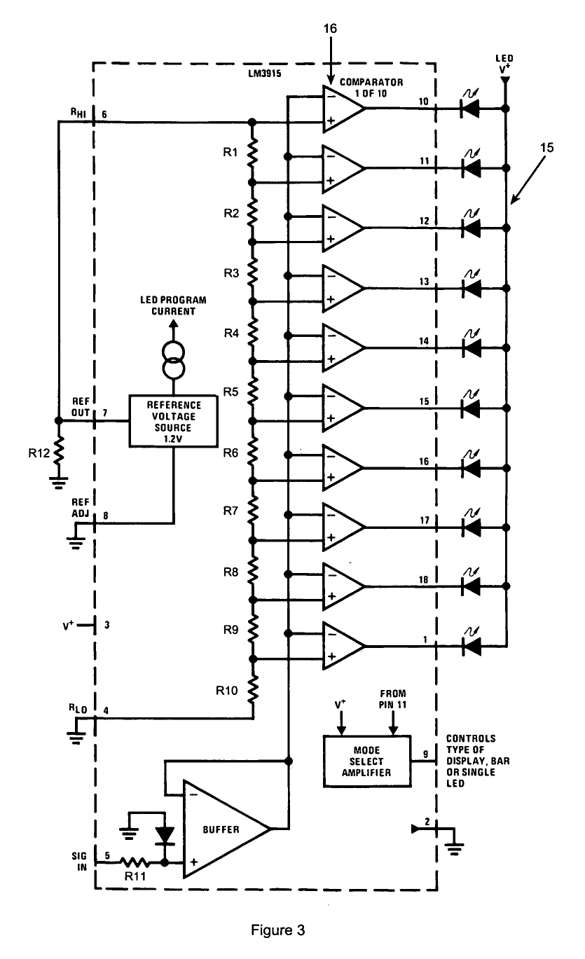

Functionally, the readily available controller as shown in FIG. 3, detects the levels of the processed signal described previously and correspondingly turns on the Light Emitting Diodes array 15 as succeeding thresholds are exceeded, providing a visual indication of increasing audible sound level in the room, similar in manner to an audio sound level meter. Additionally, comparator/display driver 6 detects the exceeding of a maximum signal threshold of comparator 16 for subsequent processing by accumulator 8.

Comparator/display driver 6 depicts the LED drive function of the Device that forms the visual feedback function of the Device. During the detection phase, these multiple LEDs provide visual indication, to anyone resident in the room, as to the level of sound in that room. The higher the sound level detected by the Device, the more LEDs that are illuminated, lighting in increasing numbers, simultaneously and sequentially from one end to the other indicating increasing sound levels. During the alarm phase of the Device, these LEDs all flash on and off in unison.

Accumulator 8 accumulates the threshold excursions detected by Comparator/display driver 6 and also provides compensation (extension) for high-level, low frequency of occurrence sounds that occur with some regularity but are sparsely distributed in time such as may be found in some forms of musical expression.

Average function 9 implements an averaging function of the signal provided by Accumulator 8. This averaging tends to allow the device to ignore singular events such as door closings and thunder claps.

Threshold detector 10 compares the voltage output of average function 9 to a set threshold and if exceeded, provides a trigger signal for alarm timer 11.

### Alarm Phase

Upon alarm timer 11 being triggered, creates an enabling signal used by mute function 3 and oscillator 12. Additionally, comparator/display driver 8, averaging function 9 and threshold detect 10 are functionally disabled and reset to an initial value representative of the condition when low levels of sound are present. This timer, upon being triggered, maintains its enabling signal for several predetermined seconds allowing the device to reset quickly on sound level abatement.

Mute function 3, when directed by alarm timer 11, disconnects microphone 2 from band pass filter 4 such that comparator/display driver 6 receives only a low level signal and thus is prevented from lighting any LEDs or performing any detection functions.

Oscillator 12, when enabled by alarm timer 11, begins oscillations such that alarm 13 is turned on and off in a repetitive fashion. Additionally, all of the LEDs that form the audio level meter are flashed on and off as the alarm is sounded by electronic switch 14, all of which are intended to draw attention to the alarm.

Alarm 13 emits an alarm sound of frequency 3000 Hertz or higher, so as to not be efficiently transmitted through shared walls and significantly contribute to overall sound transmission through the walls.

Upon the expiration of the alarm timer 11 enabling period, the Device will be returned to the Detection Phase of operation. If offending sound levels are still present, the Device will, after completing the above described Detection Phase again enter the Alarm Phase. This cycle will repeat until the offending noise levels have been reduced below the set alarm threshold.

What is claimed is:

1. An Audio Sound Level Detector and Informative Device comprising a circuit board and compact wall or ceiling mounted enclosure offering visual and audible feedback to inhabitants of an area with the intent of informing the inhabitants and or management of an area of acceptable and unacceptable audible sound levels.

2. A circuit as claimed in claim 1 that uses either an omni-directional or directional microphone for ambient sound level detection.

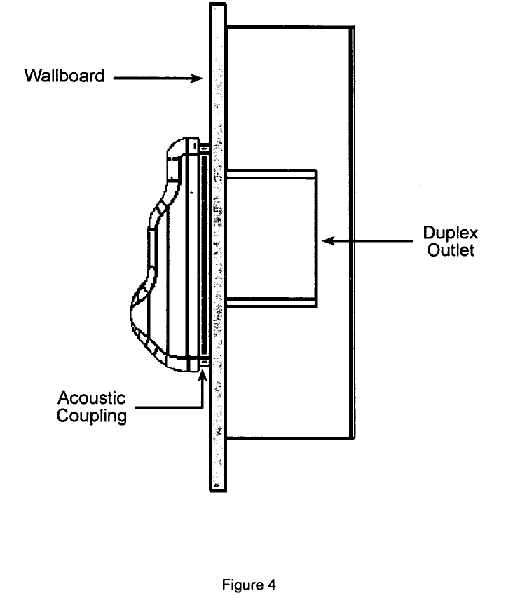

3. A circuit as claimed in claim 1 that uses either an omni directional or directional microphone and said microphone is acoustically coupled to the associated enclosure and the enclosure is coupled to the adjoining surface as in FIG. 4, allowing detection of sound energy from the surface.

4. A circuit as claimed in claim 1 that uses either omni directional or directional microphone and the microphone is acoustically coupled to its enclosure either through circuit board mounting or mounting directly to the associated enclosure.

5. A circuit as claimed in claim 1 that uses a multiplicity of either an omni directional or directional microphones and said microphones are acoustically coupled to the associated enclosure by physical means.

6. A circuit as claimed in claim 1 composed of a microphone, adjustment potentiometers and other electronic circuits in such a way as to allow detection of specific low frequency sounds in the range of 10 to 1000 Hz that tend to penetrate residential walls most efficiently.

7. A circuit as claimed in claim 1 designed with frequency characteristics and sound levels as to make the deterrent audio unlikely to pass through walls efficiently and contribute to through-wall disturbances and yet be of sufficient sound level as to interfere with the offending resident's listening pleasure.

8. A circuit as claimed in claim 1 implementing all or a majority of the functions shown in FIG. 1 using a microprocessor coupled to an Analog to Digital converter, voltage reference and signal processing circuitry.

9. A circuit as claimed in claim 1 implementing all or a majority of the functions shown in FIG. 1 using a microprocessor coupled to a discrete Analog to Digital converter, voltage reference and signal processing circuitry that incorporates into its sound level detection, indication and alarm condition functions the ability to accept and use a room-to-room vs. frequency transfer efficiency function in digital form to automatically adjust the Audio Level Meter sensitivity and alarm condition threshold.

10. An Audio Sound Level Detector and Informative Device that uses a electronic controls for adjustment of sound level processing circuitry sensitivity.

11. A device as claimed in claim 10 that uses a digitally controlled potentiometer incorporating push button switches for adjustment of sound level processing circuitry sensitivity.

12. A device as claimed in claim 10 that uses a non-volatile digitally controlled potentiometer incorporating switches for adjustment of sound level processing circuitry sensitivity.

13. A device as claimed in claim 10 that uses a commonly available potentiometer for adjustment of sound level processing circuitry sensitivity.

14. An Audio Sound Level Detector and Informative Device incorporating a method of visual feedback as the detected sound level, consisting of frequencies known to readily penetrate barriers, increases as to allow use of feedback so sound can be adjusted.

15. A device as claimed in claim 14 incorporating a row of Light Emitting Diodes (LEDs), which activate in increasing numbers as the detected sound level increases.

16. A device as claimed in claim 14 incorporating a row of LEDs whose color of light emission vary with position as the detected sound level increases.

17. A device as claimed in claim 14, which upon detecting a predetermined and programmable sound level threshold activates a high frequency audible alarm of sound pressure level greater than 75 dBA when measured from a 10 centimeter position directly in front of the Device.

18. A device as claimed in claim 14, which upon detecting a predetermined and programmable sound level threshold activates a high frequency audible alarm with such modulation as to annoy inhabitants of the monitored room in a manner similar to radio static or insect noise.

19. A device as claimed in claim 14, which upon detecting a predetermined and programmable sound level activates a high frequency audible alarm for several predetermined seconds.

20. A device as claimed in claim 14, which upon detecting a predetermined and programmable sound level activates an alarm for an increasing number of seconds with completion of each detection cycle, the incremental time of which is dependent upon the number of times a predetermined threshold was exceeded within a predetermined period of time.

21. A device as claimed in claim 14, which upon detecting several sequential alarm conditions, adjusts its alarm detection sensitivity to make alarm condition detection either more or less sensitive to the monitored environment as desirable.

22. An A device as claimed in claim 14, which upon detecting a predetermined and programmable sound level threshold disables the sound level detection circuitry for several seconds.

23. An A device as claimed in claim 14, which upon detecting a predetermined and programmable noise threshold for a predetermined amount of time automatically resets and then re-enables its detection capabilities after another predetermined period of time.

24. An Audio Sound Level Detector and Informative Device designed to be tamper resistant and or tamper evident.

25. A device as claimed in claim 24 designed to protect the circuit board adjustment access area from tampering through use of tamper proof or tamper evident labels covering the access area to a standard fastener, security screw or security lock.

26. A device as claimed in claim 24 designed to combine circuit board adjustment access area and security mounting screw access area into one access area.

27. A device as claimed in claim 24 allowing installation through use of a standard duplex plug function and thus requiring no manual wiring or use of wire nuts, wire crimps or wiring tools.

28. A device as claimed in claim 24 using tamper resistant screw(s) to secure the device to the surface via a common duplex outlet.
